(19) United States
(12) Patent Application Publication
(10) Pub. No.: US 2012/0330694 A1
(43) Pub. Date: Dec. 27, 2012

(54) REVENUE INTEGRITY MANAGER

(75) Inventors: Raelynn A. Sink, Lakeville, MN (US); Scott Keller, Salt Lake City, UT (US)

(73) Assignee: Accenture Global Services Limited, Dublin (IE)

(21) Appl. No.: 13/282,041

(22) Filed: Oct. 26, 2011

Related U.S. Application Data
(60) Provisional application No. 61/500,990, filed on Jun. 24, 2011.

(51) Int. Cl. G06Q 10/02

(52) U.S. Cl. 705/5

(57) ABSTRACT

Methods, systems, and apparatus, including computer programs encoded on a computer storage medium, for monitoring booking data are disclosed. In one aspect, a method includes retrieving booking data from a computer-readable storage device and processing the data using an analyzer of a plurality of analyzers to generate at least one score. In addition, the method includes comparing a value of the at least one score to a threshold value, determining that the value exceeds the threshold value. The method further includes generating an event in response to determining that the value exceeds the threshold value, the event indicating a presence of one or more criteria that generated the data, and transmitting the event to a computing device to be displayed to a user of the computing device.

### CROSS REFERENCE TO RELATED APPLICATION

This application claims the benefit of U.S. Provisional Patent Application No. 60/500,990, filed Jun. 24, 2011 and titled “Revenue Integrity Manager,” the contents of which are hereby incorporated by reference in its entirety.

### TECHNICAL FIELD

This specification generally relates to systems and processes for managing revenue integrity.

### BACKGROUND

An industry that uses booking data (e.g., the airline industry, the hotel industry) may have loopholes in their processes and distribution. These loopholes can result in loss of revenue for the entities involved in the industry (e.g., individual airlines and hotels). Revenue leakage can cost these industries significant amounts of lost revenue. A system for monitoring booking data that analyzes the data against a set of predetermined criteria may identify abuse of the rules or policies that the industry has in place. An industry entity may use the results of the analysis in order to manage their booking processes and distribution.

### SUMMARY

In general, one innovative aspect of the subject matter described in this specification may be embodied in systems and processes used for managing revenue integrity to prevent revenue leakage. A revenue integrity system can manage revenue integrity for an industry entity (e.g., an airline, a hotel). The revenue integrity system can be a system that includes a revenue integrity engine that uses one or more revenue integrity analyzers. The revenue integrity engine can use the one or more analyzers to analyze data on a regular basis. The data can include, but is not limited to, booking data flight data, personal customer-centric data, conditional data (e.g., the current date relative to booking information). The analysis can compare the booking data to a known set of criteria to determine if any of the data included in the booking data violates any rules. Rule violations in a system can be practices occurring in the system that abuse the system's rules or policies. If a rule violation occurs, the revenue integrity engine can inform a user (e.g., an airline employee for an airline, the hotel manager for a hotel) of the violation for further processing by the user.

In some implementations, each revenue integrity analyzer can focus on a particular identified rule violation practice. The revenue integrity system provider can provide a default set of rules for each analyzer. The analyzer can compare the booking data against the default set of rules to determine rule violations. In some cases, the industry entity can customize the set of rules for each analyzer. The entity can use the customization to tailor the criteria regarding the rule violations towards their business needs. The criteria can include a scoring methodology for comparing the analysis results against a predetermined score to determine if one or more rule violations have occurred. Additional criteria can include, but is not limited to, the data within the booking data to check, how to check the selected data, and the order in which to check the selected data.

In some implementations, each revenue integrity analyzer can provide rule violation information regarding a particular booking on an as needed basis. The as needed basis can be determined by the entity and customized in the set of rules used by the analyzer. In some cases, the revenue integrity system can provide rule violation information in the form of an alert or event on a real time basis. In some cases, the revenue integrity system can provide rule violation information on a scheduled basis (e.g., once per day). For example, the revenue integrity system can present the rule violation information to the user as a real time stream of news events. In another example, the revenue integrity system can present the rule violation information to the user in a report format.

An example implementation of a revenue integrity system can include a dashboard for display on an operator display device that can provide the results of the revenue integrity analyzers to a user within a graphical user interface (GUI). The interface can provide the user with “news” and information regarding determined rule violations in the timeframe selected by the user (e.g., daily, hourly or in a real time, streaming basis). The user can further interact with the GUI to determine specific information regarding the rule violation in order to determine if the user may need to take any further actions.

Particular embodiments of the subject matter described in this specification may be implemented to realize one or more of the following advantages. Specifically, the methods and systems disclosed can protect travel entity revenue by detecting and preventing or by performing a predefined action automatically when business policy violations or errors are identified. In addition, the methods and systems disclosed can customize and identify patterns of abuse occurring in a system across millions of data records. The methods and systems disclosed can alert travel entity resources interactively based on the automated detection of errors or abuses. The methods and systems disclosed can provide improved control over inventory or “stock” (e.g., an airline seat, a hotel room) as well as improved control over the distribution of the inventory as per planned business methods. The methods and systems disclosed can customize and write analyzers that can detect patterns or occurrences of abuse that may be specific to a travel entity. The methods and systems disclosed can prevent distributors from spoiling or otherwise corrupting the inventory or “stock.” In addition, the methods and systems disclosed can prevent passengers or other consumers of the inventory or “stock” from exploiting loopholes in the systems.

The details of one or more embodiments of the subject matter described in this specification are set forth in the accompanying drawings, and the description, below. Other features, aspects and advantages of the subject matter will be apparent from the description and drawings, and from the claims.

### BRIEF DESCRIPTION OF DRAWINGS

Referring now to the drawings, in which like reference numbers represent corresponding parts throughout:

FIG. 1 is a block diagram illustrating an example system that can execute implementations of the present disclosure.

FIG. 2 is a block diagram illustrating an example revenue integrity system.

FIG. 3 is a screen shot of an example dashboard user interface for a revenue integrity system.

FIG. 4 is a screen shot of an example dashboard user interface showing an example business rules menu that includes settings for a revenue integrity system.

FIG. 5 is a screen shot of an example dashboard user interface for a revenue integrity system showing an example duplicate bookings menu.

FIG. 6 is a screen shot of an example configuration user interface for a revenue integrity system.

FIG. 7 is a screen shot of an example configuration user interface showing a menu for adding a rule to a revenue integrity system.

FIG. 8 is a screen shot of an example scheduling user interface for a revenue integrity system.

FIG. 9 is a screen shot of an example news user interface for a revenue integrity system.

FIG. 10 is a flow chart of an example method that can execute implementations of the present disclosure.

### DETAILED DESCRIPTION

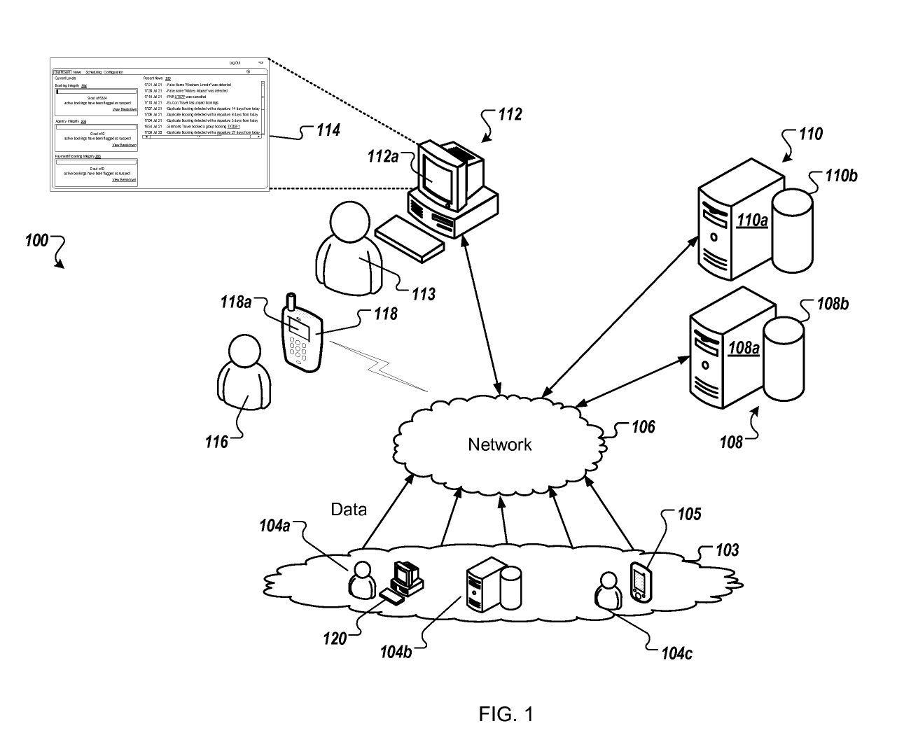

FIG. 1 is a block diagram illustrating an example system 100 that may execute implementations of the present disclosure. The system 100 includes a booking data computing system 108 that includes a booking data server 108a and a booking database 108b. The booking data computing system 108 communicates with input data sources 104a-c by way of a network 106. For example, the input data sources 104a-c can access and store booking data in the booking database 108b.

As shown in the example of FIG. 1, input data sources can include, but are not limited to, a travel agent 104a at a travel agency, a passenger 104c using a mobile computing device 105, and other booking sources 104b (e.g., an online booking agency). For example, the travel agent 104a can enter booking data for a customer on an agency computing device 120 that can transmit the data using the network 106 to the booking data computing system 108 for storage in the booking database 108b. In another example, the travel agent 104a can access booking data for a customer. The agency computing device 120 can send a request for the customer booking data to the booking data computing system 108 by way of the network 106. The booking data server 108a can access the booking database 108b to retrieve and then send the booking data for the customer to the agency computing device 120 by way of network 106. For example, the passenger 104c can use a mobile computing device 105 (e.g., a mobile phone, a smart phone, a notebook device, or a notepad device) to access the booking data computing system 108 in order to request their booking data from the booking database 108b. The booking data server 108a can access the passenger's booking data on the booking database 108b and send it to the mobile computing device 105 by way of network 106. In some implementations, input data sources 104a-c may be event sources that provide event information (e.g., a booking has occurred) to an event based application executing on the booking data computing system 108.

The system 100 includes a revenue integrity computing system 110 that includes a revenue integrity server 110a and a revenue integrity database 110b. The revenue integrity computing system 110 can communicate with the booking data computing system 108 by way of the network 106. The booking data computing system 108 can provide booking data from the booking database 108b to the revenue integrity computing system 110. The revenue integrity computing system 110 can perform revenue integrity analysis using the booking data provided by the booking data computing system 108. The revenue integrity computing system 110 can run one or more revenue integrity analyzers stored in the revenue integrity database 110b. In addition, rules for use with each revenue integrity analyzer may also be stored in the revenue integrity database 110b.

The system 100 includes a client computing system 112. An administrator 113 can use the client computing system 112 to interact with the revenue integrity computing system 110 and the booking data computing system 108 by way of the network 106. The client computing system 112 can provide the administrator 113 with a GUI for display on the client display device 112a included in the client computing system 112. The administrator 113 can use the GUI to interact with the revenue integrity computing system 110 and the booking data computing system 108. For example, the administrator 133 can access customer booking data stored in the booking database 108b for one or more customers by having the client computing system 112 interact with the booking data computing system 108 by way of the network 106. The GUI of the client display device 112a can display the customer's booking data for viewing by the administrator 113.

In addition, the administrator 113 can access one or more revenue integrity analyzers on the revenue integrity computing system 110. For example, the administrator 113 can access the one or more revenue integrity analyzers by having the client computing system 112 communicate with the revenue integrity computing system 110 by way of the network. The client display device 112a can display a GUI (e.g., a dashboard 114) that allows the administrator 113 to interact with the revenue integrity analyzers. The revenue integrity computing system 110 can provide a GUI for display on the client display device 112a that can provide the administrator 113 with an interface for selecting and, in some cases customizing, the rules for use by the analyzer when performing the analysis of the booking data. The revenue integrity computing system 110 can provide a GUI for display on the client display device 112a that can provide the administrator 113 with the ability to schedule the revenue integrity analysis. In addition, the client computing system 112 can monitor the results of the revenue integrity analysis using a GUI. The administrator 113 can view the results of the revenue integrity analysis to determine if any suspicious booking activity has occurred.

In some cases, an administrator or other qualified user 116 can use a mobile computing device 118 to interact with the revenue integrity computing system 110. For example, the mobile computing device 118 can communicate with the revenue integrity computing system 110 wirelessly by way of network 106. A display 118a of the mobile computing device 118 can display a modified (e.g., simplified) GUI for use by the user 116 for interacting with the revenue integrity computing system 110. The modified GUI can provide the user 116 with an interface for selecting the rules for use by the analyzer. The modified GUI can provide the user 116 with an interface that allows the user to schedule the revenue integrity analysis. In addition, the mobile computing device 118 can monitor the results of the revenue integrity analysis. The user 116 can view the results of the revenue integrity analysis on the display 118a to determine if any suspicious booking activity has occurred. For example, the administrator 113 may be located in a service center. The administrator 113 can set up the monitoring and analysis of the booking data stored in the booking database 108b by the revenue integrity computing system 110. The qualified user 116 can then monitor the results of the revenue integrity analysis using the mobile computing device 118. The qualified user 116 need not be located at the service center but may be located at a remote location (e.g., an agent located at a particular airport).

The client computing system 112 can receive news and alerts about rule violations. The revenue integrity computing system 110 can determine the rule violations when executing one or more revenue integrity analyzers. For example, a revenue integrity analyzer can use the rules stored in the revenue integrity database 110b. The revenue integrity analyzer can compare the rules against booking data stored in the booking database 108b. The revenue integrity analyzer can identify one or more rules violated by the booking data. The revenue integrity computing system 110 can provide the identified booking data and the one or more violated rules to the client computing system 112 by way of network 106. The client computing system 112 can display the identified booking data and the violated rules in a GUI on the client display device 112a for review by the administrator 113. In addition, the mobile computing device 118 can also receive news and alerts about rule violations in a similar manner as the client computing system 112. The mobile computing device 118 can display the identified booking data and the violated rules in a GUI on the mobile display device 118a. The qualified user 116 can then review the results of the rule violations.

The client computing system 112 may represent various forms of processing devices including, but not limited to, a desktop computer, a laptop computer, and a handheld computer. The client computing system 112 may access application software on the revenue integrity computing system 110 and the booking data computing system 108. The booking data server 108a and the revenue integrity server 110a can represent various forms of servers including, but not limited to a web server, an application server, a proxy server, a network server, or a server farm. For example, the booking data computing system 108 can include an application server that executes software accessed by client computing system 112. For example, the revenue integrity computing system 110 can include an application server that executes software accessed by client computing system 112.

In operation, the client computing system 112 and the mobile computing device 118 can communicate with the revenue integrity computing system 110 and the booking data computing system 108 by way of network 106. The client computing system 112 can include one or more central processing units (CPUs) that may execute programs and applications included on the client computing system 112. The revenue integrity computing system 110 can include one or more central processing units (CPUs) that may execute programs and applications included on the revenue integrity computing system 110. For example, a program or application may analyze booking data. The booking data computing system 108 can include one or more central processing units (CPUs) that may execute programs and applications included on the booking data computing system 108. For example, a program or application may manage the booking data stored in the booking database 108b.

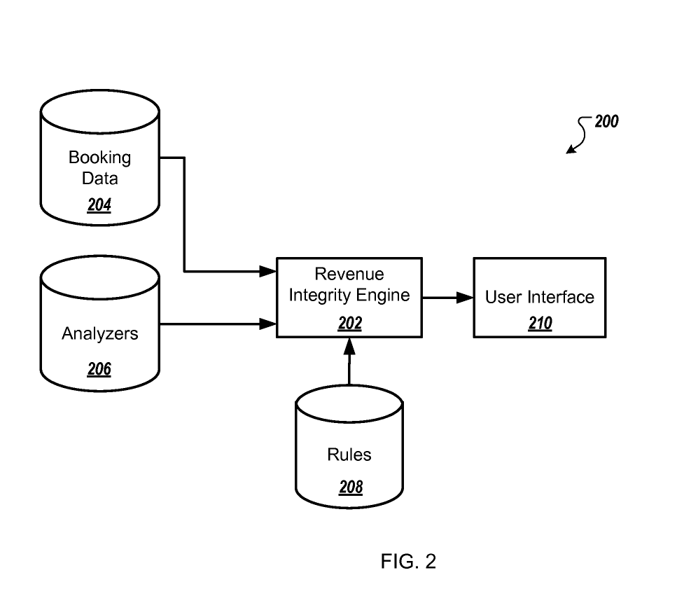

FIG. 2 is a block diagram illustrating an example revenue integrity system 200. The system 200 includes a revenue integrity engine 202 that accesses one or more repositories, including but not limited to, a booking data repository 204, an analyzer repository 206, and a rule repository 208. For example, referring to FIG. 1, the revenue integrity computing system 110 can include the revenue integrity engine 202. In some implementations, the revenue integrity database 110b can include the analyzer repository 206 and the rule repository 208. In some implementations, the booking database 108b in the booking data computing system 108 can include the booking data repository 204. As described, the revenue integrity computing system 110 can communicate with the booking data computing system 108 by way of network 106. This allows the revenue integrity engine 202 to access booking data included in the booking data repository 204.

As described, the revenue integrity computing system 110 can communicate with the client computing system 112 by way of network 106. The revenue integrity engine 202 can provide a GUI (e.g., the dashboard 114) for display on the client display device 112a. The administrator 113 can interact with a GUI to provide the revenue integrity engine 202 with the information it needs in order to configure, schedule and monitor one or more revenue integrity analyzers included in the analyzer repository 206. For example, the administrator 113 can interact with a GUI to select the booking data for analysis. In addition, the administrator 113 can interact with a GUI to configure the booking data analysis by selecting the revenue integrity analyzers for use by the revenue integrity engine 202 and the rules the revenue integrity analyzers should apply to the booking data in the analysis of the booking data. The analysis may also include the use of additional data such as flight event data and schedules data. The additional data may be included in the booking data repository 204 or in an additional database included in the system 100 and accessible by the revenue integrity engine 202.

The revenue integrity engine 202 can compare the booking data to one or more rules included in the rule repository 208 using a revenue integrity analyzer included in the analyzer repository 206. In some implementations, rules and analyzers may be included in a single repository as the analyzer utilizes one or more rules when analyzing the data. The administrator 113, interacting with a GUI, can select the rules the revenue integrity engine 202 will use in its analysis of the booking data from the rules stored in the rule repository 208. In some implementations, the client display device 112a may present the administrator 113 with a GUI that allows the administrator 113 to select a rule from the rule repository 208. In addition, the GUI may allow the administrator 113 to further modify or customize the selected rule for use by the revenue integrity engine 202 and a revenue integrity analyzer. For example, a customized rule may include the analysis of specific information or data included in the booking data that may be unique to the client (e.g., in the case of an airline, if the booking data is for a domestic or international flight).

In some implementations, the revenue integrity engine 202 can apply the selected rules to all of the booking data included in the booking data repository 204. In some implementations, the revenue integrity engine 202 can apply the selected rules to a subset of the booking data included in the booking data repository 204. For example, the revenue integrity engine 202 may apply the selected rules to booking data included in the booking data repository 204 that the revenue integrity engine 202 did not previously analyze. In some implementations, the revenue integrity engine 202 may apply the selected rules to a subset of the booking data based on a date or time stamp included with the booking data. In some implementations, the revenue integrity engine 202 may use other predefined characteristics of the booking data (e.g., in the case of airline reservations, the particular airline, in the case of hotel reservations, the particular hotel or hotel chain) to determine a subset of the booking data for analysis. For example, a particular airline may require the analysis of its booking data be performed on real-time basis. In another example, a particular hotel chain may require the analysis of its booking data be performed on a scheduled basis (e.g., hourly or daily at 1:00 am).

In some implementations, the client display device 112a may present the administrator 113 with a GUI that allows the administrator 113 to select a schedule for the analysis and monitoring of the booking data. The selections can include monitoring and analyzing the booking data on a scheduled basis (e.g., hourly, daily, weekly). The revenue integrity computing system 110 can communicate the results of the analysis of the booking data by the revenue integrity engine 202 to the client computing system 112 by way of network 106. For example, the revenue integrity computing system 110 can provide a report to the client computing system 112 for display to the administrator on the client display device 112a. The report can include the identity of each booking in violation of one or more of the applied rules indicating the one or more rules violated by the booking. In addition, each booking can include a record locator and customer name.

The administrator 113 may select the revenue integrity engine 202 perform the analysis and monitoring of the booking data on a real-time basis. Monitoring the booking data on a real-time basis can include streaming alerts to the client computing system 112 of any booking in violation of any of the applied rules. For example, the revenue integrity engine 202 can flag the booking in the booking data that is in violation of a rule. The revenue integrity computing system 110 can communicate the identity of the booking and the one or more rules it violates to the client computing system 112 by way of network 106 in the form of an alert or event. The client display device 112a can display the identity of the booking (e.g., displaying information associated with the booking data such as a record locator and customer name) on the client display device 112a.

Once notified of the violation, the administrator 113 can determine the course of action to take to try to correct or eliminate the rule violation. In some cases, a course of action may be to alert any concerned entities (e.g., a travel agency, an airline, a hotel) of the rule violation in order for the entity to intercept or cancel the bookings. For example, a revenue integrity analyzer analyzes booking data based on a customer name. A rule is to determine the use of a predetermined fictitious customer name (e.g., “Mickey Mouse”). For example, the revenue integrity engine 202, using a revenue integrity analyzer, analyzes each booking included in the booking data for the customer name, “Mickey Mouse”. The revenue integrity engine 202 flags the booking as including a “fake” name if the customer name for the booking is “Mickey Mouse”. The revenue integrity computing system 110 can communicate the booking data for the flagged booking to the client computing system 112. In the case of streaming alerts, the client display device 112a displays the reason for flagging the booking as a news item to the administrator 113. The administrator 113 can then further interact with a GUI to retrieve the data for the flagged booking.

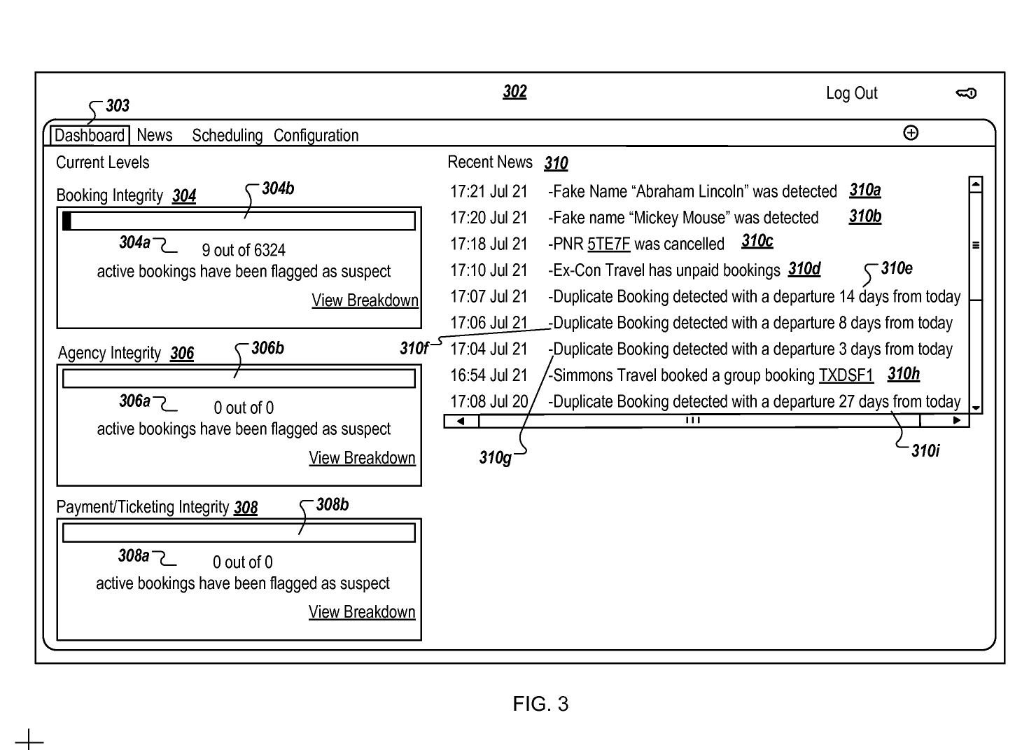

FIG. 3 is a screen shot of an example dashboard user interface (UI) 302 for a revenue integrity system. For example, referring to FIG. 1, the client display device 112a can display the dashboard UI 302 (e.g., as dashboard 114) to the administrator 113 on the client display device 112a when the administrator 113 selects the “Dashboard” tab 303. The administrator 113 can interact with the dashboard UI 302 to determine the status of the analysis of the booking data by the revenue integrity system 200 previously described with reference to FIGS. 1 and 2.

For example, referring to FIGS. 1 and 2, an administrator 113 can monitor booking data integrity using the example dashboard UI 302 in the system 100. The administrator 113 interacting with the dashboard UI 302 can determine the current integrity levels for particular integrity categories (e.g., booking integrity, agency integrity, and payment/ticketing integrity) by viewing and interacting with a booking integrity window 304, an agency integrity window 306, and a payment/ticketing integrity window 308.

An integrity category can be associated with a revenue integrity analyzer. For example, the booking integrity category can be associated with one or more revenue integrity analyzers included in the analyzer repository 206. A booking integrity analyzer can analyze booking data with respect to the data included in the booking (e.g., the customer name, booking date). For example, the agency integrity category can be associated with one or more revenue integrity analyzers included in the analyzer repository 206. An agency integrity analyzer can analyze travel agency data related to a booking (e.g., the agency has unpaid bookings, the agency has generated a group booking). For example, the payment/ticketing integrity category can be associated with one or more revenue integrity analyzers included in the analyzer repository 206. A payment/ticketing integrity analyzer can analyze booking data with respect to the method of payment and ticket type for the booking (e.g., credit card number used for payment, electronic ticket issued, paper ticket issued).

The booking integrity window 304, the agency integrity window 306, and the payment/ticketing integrity window 308 can provide the number of active bookings that have been identified (flagged) as suspect or suspicious bookings in relation to the total number of bookings as shown by a booking integrity indicator 304a, an agency integrity indicator 306a, and a payment/ticketing integrity indicator 308a, respectively. In addition, a booking integrity bar 304b, an agency integrity bar 306b, and a payment/ticketing integrity bar 308b included in the booking integrity window 304, the agency integrity window 306, and the payment/ticketing integrity window 308, respectively, can visually indicate the number of potential booking violations in comparison to the total number of bookings for each of the respective categories.

A recent news window 310 displays news or alerts regarding a detected rule violation. The recent news window 310 displays the news or alerts in a real-time streaming basis. For example, recent news items 310a and 310b indicate the detection of a fake or fictitious name. For example, referring to FIG. 2, the revenue integrity engine 202 can use a fictitious name analyzer included in the analyzer repository 206 to analyze the booking data included in the booking data repository 204. The revenue integrity engine 202 can perform the analysis of the booking data for the detection of fictitious names using one or more rules included in the rule repository 208 (e.g., a list of identified fictitious names that includes “Abraham Lincoln” and “Mickey Mouse”). The results of the analysis can be included as part of the booking data category. As shown in FIG. 3 by recent news items 310a and 310b, the result of the fictitious names analyzer is the identification of the fictitious names “Abraham Lincoln” and “Mickey Mouse”, respectively, which were included in the list of fictitious names for detection by the fictitious names analyzer.

The recent news window 310 displays recent news items 310e, 310f, 310g, and 310j that indicate detected duplicate bookings. A duplicate booking can represent multiple bookings for the same customer to and from the same destinations within a defined timeframe. For example, a customer may book multiple refundable tickets where the return flight is at different times on the same day. They can then decide on the day of travel when they prefer to depart and cancel the tickets they do not use at the last minute, receiving a full refund. For example, the revenue integrity engine 202 can use a duplicate booking analyzer included in the analyzer repository 206 to analyze the booking data included in the booking data repository 204. The revenue integrity engine 202 can perform the analysis of the booking data for the detection of duplicate bookings using one or more rules included in the rule repository 208 (e.g., customer departure city remains the same, customer return city remains the same, both the departure and return city remain the same). The results of the analysis can be included as part of the booking data category. As shown in FIG. 3 by recent news items 310e, 310f, 310g, and 310j, the duplicate booking analyzer detected the duplicate bookings.

In addition, for example, booking data can be analyzed for other criteria including, but not limited to, no shows and name changes. For example, the revenue integrity engine 202 can use a no show analyzer included in the analyzer repository 206 to analyze the booking data included in the booking data repository 204. The revenue integrity engine 202 can perform the analysis of the booking data for the detection of no shows using one or more rules included in the rule repository 208 (e.g., customer does not show for return flight, customer does not show for departing flight). In the case of a refundable or changeable fare, the airline may want to determine if identifiable circumstances surround when the no show (e.g., a rise in the number of no shows in a particular city during a major event hosted by the city). The revenue integrity engine 202 can perform the analysis of the booking data for the detection of bookings where no shows occurred using the selected one or more rules. The results of the analysis can be included as part of the booking data category.

The revenue integrity engine 202 can analyze booking data using one or more revenue integrity analyzers included in the analyzer repository 206 for criteria related to the agency integrity category. For example, the revenue integrity engine 202 can use an agency churn analyzer included in the analyzer repository 206 to analyze the booking data included in the booking data repository 204. Agency churn can involve the practice by a travel agency of rebooking or churning bookings repeatedly in order to hold space on a particular flight. The revenue integrity engine 202 can perform the analysis of the booking data for the detection of agency churn using one or more rules included in the rule repository 208 (e.g., a travel agency rebooks the same flights three or more times for the same customer every 24 hours). The results of the analysis can be included as part of the agency integrity category.

In another example, the revenue integrity engine 202 can use an agency suspicious behavior analyzer included in the analyzer repository 206 to analyze the booking data included in the booking data repository 204. The revenue integrity engine 202 can perform the analysis of the booking data for the detection of suspicious agency behavior, using one or more rules to define the behavior, that are included in the rule repository 208. Example rules can include, but are not limited to, detecting when a travel agency has a number of unpaid bookings above a certain threshold number (defined by the rule) and, for a particular travel agency, detecting every group booking performed by the agency. The results of the analysis can be included as part of the agency integrity category. As shown in FIG. 3 by recent news items 310d and 310i, the agency suspicious behavior analyzer detected the unpaid bookings and the group bookings, respectively.

The revenue integrity engine 202 can analyze booking data using one or more revenue integrity analyzers included in the analyzer repository 206 for criteria related to the payment/ticketing integrity category. The criteria can include the type and method of payment for the ticket and the method of ticketing. For example, the revenue integrity engine 202 can use a credit card fraud analyzer included in the analyzer repository 206 to analyze the booking data included in the booking data repository 204. The revenue integrity engine 202 can perform the analysis of the booking data for the detection of credit card fraud using one or more rules included in the rule repository 208 (e.g., the number of declined credit card charges for a particular credit card exceeding a threshold value). The results of the analysis can be included as part of the payment/ticketing integrity category. In another example, the revenue integrity engine 202 can use a ticket number analyzer included in the analyzer repository 206 to analyze the booking data included in the booking data repository 204. The revenue integrity engine 202 can perform the analysis of the booking data for the detection of fraudulent ticket numbers using one or more rules included in the rule repository 208 (e.g., the ticket number is outside of a specified reasonable tolerance for a ticket number). The results of the analysis can be included as part of the payment/ticketing integrity category.

In an additional example, the revenue integrity engine 202 can use a back to back ticketing analyzer included in the analyzer repository 206 to analyze the booking data included in the booking data repository 204. Back to back ticketing involves the combining of multiple overlapping round trip tickets in order to circumvent Saturday or other additional overnight stay requirements to take advantage of reduced fares. The revenue integrity engine 202 can perform the analysis of the booking data for the detection of back to back ticketing using one or more rules included in the rule repository 208 (e.g., the customer is issued a round trip ticket to depart from a city prior to their return flight on a different round trip ticket from the same city). The results of the analysis can be included as part of the payment/ticketing integrity category.

For example, the revenue integrity engine 202 can use a throw away ticket analyzer included in the analyzer repository 206 to analyze the booking data included in the booking data repository 204. Throwaway ticketing involves the use of discounted round trip fares for one-way travel. The revenue integrity engine 202 can perform the analysis of the booking data for the detection of throwaway ticketing using one or more rules included in the rule repository 208 (e.g., the customer is issued a round trip ticket and does not board the return flight). The results of the analysis can be included as part of the payment/ticketing integrity category.

In another example, the revenue integrity engine 202 can use a point beyond ticketing analyzer included in the analyzer repository 206 to analyze the booking data included in the booking data repository 204. Point beyond ticketing involves the use of a ticket booked with a stopover where the customer deplanes at the stopover point and never returns to the plane to continue the flight to the destination city. The revenue integrity engine 202 can perform the analysis of the booking data for the detection of point beyond ticketing using one or more rules included in the rule repository 208 (e.g., the customer is issued a ticket and does not reboard the plane for the remaining segment of the flight). The results of the analysis can be included as part of the payment/ticketing integrity category.

Each analyzer can use a set of rules stored in the rule repository 208. The rules can be a set of default rules provided by the revenue integrity system provider (e.g., the provider of the revenue integrity system 200 in FIG. 2). In some implementations, an administrator or other qualified user (e.g., administrator 113 or qualified user 116 in FIG. 1) can customize the one or more rules stored in the rule repository 208. For example, referring to FIG. 1, the revenue integrity computing system 110 can provide the client computing system 112 with a GUI for display on the client display device 112a. The administrator 113 can interact with the GUI to select and customize rules. The customization can reflect certain criteria for a particular client. For example, an airline that does not sell refundable tickets may not use certain rules related to no show analysis. In fact, an airline that does not sell refundable tickets may choose not to perform no show analysis.

In some implementations, as described, the revenue integrity engine 202 can use a single analyzer for each identified potential rule violation. The results of the analysis can then be grouped by integrity category and reported in the integrity category. In some implementations, one or more analyzers can be grouped together into a single analyzer. As described, an integrity category (e.g., the booking integrity category) can use multiple analyzers to perform analysis on the booking data for the particular category. The analyzers used for a single integrity category can be grouped together into a single analyzer using a single set of rules (where the set of rules for each individual analyzer can be grouped together into the single set of rules). The single analyzer can provide validation checks for multiple possible rule violations in a single analysis step for the integrity category.

In performing the analysis of the booking data, the revenue integrity analyzer applies one or more rules or a set of rules to the booking data to determine the integrity of the booking data. The result of the analysis of the booking data compared to the one or more rules can be a score whose value is dependent on the number of rules in the set of one or more rules violated by the booking data. For example, the higher the score the more rules the booking data violates. In some implementations, the score assigned to the rule can be dependent on the rule itself where the violation of one of the rules in the set of rules results in a higher score than the violation of a different rule in the set of rules. The resulting score for the analysis of the booking data is the sum of all the scores produced by the one or more rule violations.

In addition, each analyzer includes scoring criteria for one or more entries in the booking data. The analyzer can use a set of rules that compares the one or more entries in the booking data to a predetermined value or rule. If the comparison of the rule to the entry is met (the booking data violates the rule), the analysis result will be incremented by the value of the score associated with the rule. Some booking data entries, when matched to a rule, may result in a higher score than other booking data entries when matched to a different rule. In addition, once the analysis is complete and a total score is determined for the booking data, the total score can be compared to a threshold score and if the total score exceeds the threshold score, the booking data is flagged. As such, the scoring criteria includes a score for each booking data entry compared to a rule and a total threshold score level for the analyzer that if exceeded then flags the booking data as a rule violator.

The rules and the scoring criteria for the rules can be provided by the revenue integrity system provider and included with the corresponding rule in the rule repository 208. The threshold scores can be provided by the revenue integrity system provider and included with a revenue integrity analyzer in the analyzer repository 206. In some implementations, the revenue integrity computing system 110 can provide a GUI to the client computing system 112 for display on the client display device 112a to the administrator 113. The administrator 113 can interact with the GUI to provide and/or modify a score associated with a rule. As such, the administrator 113 can customize the rules scoring for a particular client. For example, a particular client may be more sensitive to duplicate bookings than no shows. In addition, the administrator 113 can interact with a GUI in order customize the threshold score. Therefore, the administrator for an entity (e.g., an airline) can establish how to score a violation and the total threshold score level for each revenue integrity analyzer.

In some implementations, multiple revenue integrity analyzers can use the same booking data where each data entry in the booking can be analyzed against different criteria and can therefore result in a different score, where the score can be associated with the revenue integrity analyzer. As such, each analyzer provides a score. The revenue integrity computing system 110 can act on the booking data dependent on the score and the analyzer producing the score. For example, if the score for the analysis of the booking data by the duplicate booking analyzer exceeds the established threshold score, indicating the booking is a duplicate, the revenue integrity computing system 110 may cancel the booking. In another example, if the score for the analysis of the booking data by the credit card fraud analyzer exceeds the established threshold score, the revenue integrity computing system 110 can send an alert or news item to the client computing system 112 for display on the client display device 112a alerting the administrator 113 to the possibility of credit card fraud for the booking. In another example, if the score for the analysis of the booking data by the agency suspicious behavior analyzer exceeds the established threshold score, the revenue integrity computing system 110 may queue the booking data for further analysis.

In some implementations, the revenue integrity computing system 110 can provide a GUI to the client computing system 112 for display on the client display device 112a to the administrator 113. The administrator 113 can interact with the GUI to select the analyzers used to analyze the booking data as well as the rules used by each analyzer. The administrator 113 can prioritize the application of the analyzers to the data. In addition, the administrator 113 can prioritize the application of the rules to the data for each analyzer. In some cases, when the threshold score is reached, the analysis of the booking data can cease and the booking data can be flagged. In other cases, the analysis of the booking data will continue to completion even after the threshold score has been reached. The resultant value of the score associated with the booking data can provide an indication of the severity of the rule violations as the value of the score can be greater than the threshold score.

The industry entity (e.g., an airline) can build and determine the applied rules for use by the revenue integrity analyzers. The level of granularity for the rules can be as fine as taking any amount of data out of a booking record and making it into a rule. For example, booking data may include the seating preference on a plane for the customer. For example, a rule can be used for the seating data that provides a higher score for a window seat than an aisle seat when the booking data is analyzed by a seat analyzer.

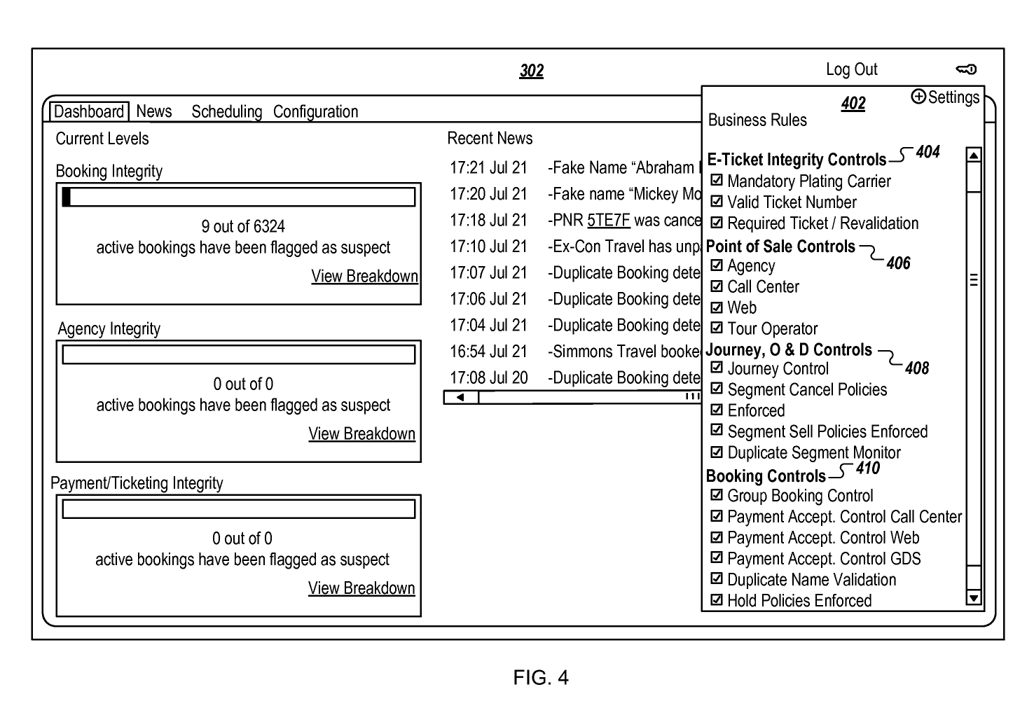

FIG. 4 is a screen shot of the example dashboard user interface (UI) 302 showing an example business rules menu 402 that includes settings for a revenue integrity system. The business rules menu 402 includes a set of business rules for an industry entity (e.g., an airline). For example, referring to FIG. 1, the client computing system 112 can display the dashboard UI 302 including the menu 402 on the client display device 112a. The administrator 113 can select control settings from a set of one or more control settings for use as a business rule when accepting and generating booking data for a customer. The business rules are associates with E-ticket integrity controls 404, point of sale controls 406, journey, origin and destination (O&D) controls 408 and booking controls 410. For example, point of sale controls 406 include the selection of the acceptable points of sale for the booking that can include an agency, a call center, the Web or a tour center.

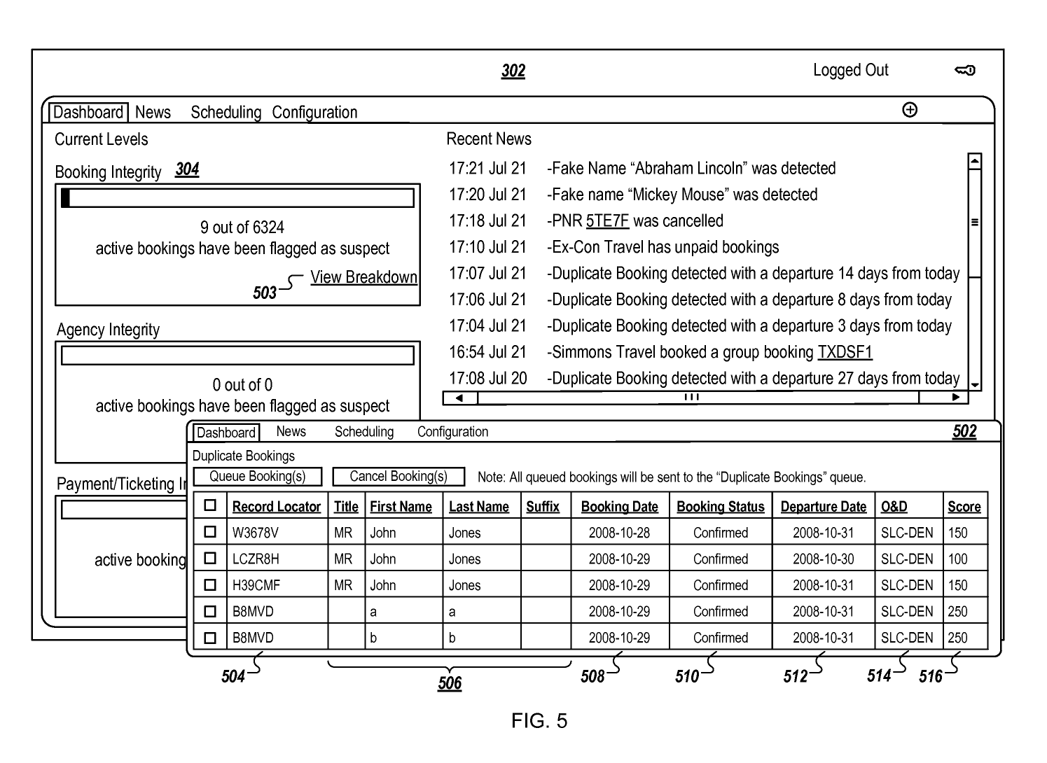

FIG. 5 is a screen shot of an example dashboard user interface (UI) 302 for a revenue integrity system showing an example duplicate bookings menu 502 that includes a breakdown of identified violations. For example, referring to FIG. 1, the client computing system 112 can display the dashboard UI 302 including the duplicate bookings menu 502 on the client display device 112a. The administrator 113 can select the “View Breakdown” entry 503 in the booking integrity window 304 in order to activate the duplicate bookings menu 502. The duplicate bookings menu 502 includes a list of one or more suspected, flagged bookings that potentially violate at least one of the rules applied to the booking data by the duplicate booking analyzer. The duplicate bookings menu 502 allows the administrator to view the booking data as used by the duplicate booking analyzer. Each entry in the duplicate bookings menu 502 includes a record locator 504, a customer name 506, a booking date 508, a booking status 510, a departure date 512, an origin and destination (O&D), and a score 516. For example, the threshold score for the duplicate booking analyzer can be “100”. As shown in the duplicate bookings menu 502, each entry meets or exceeds the threshold score.

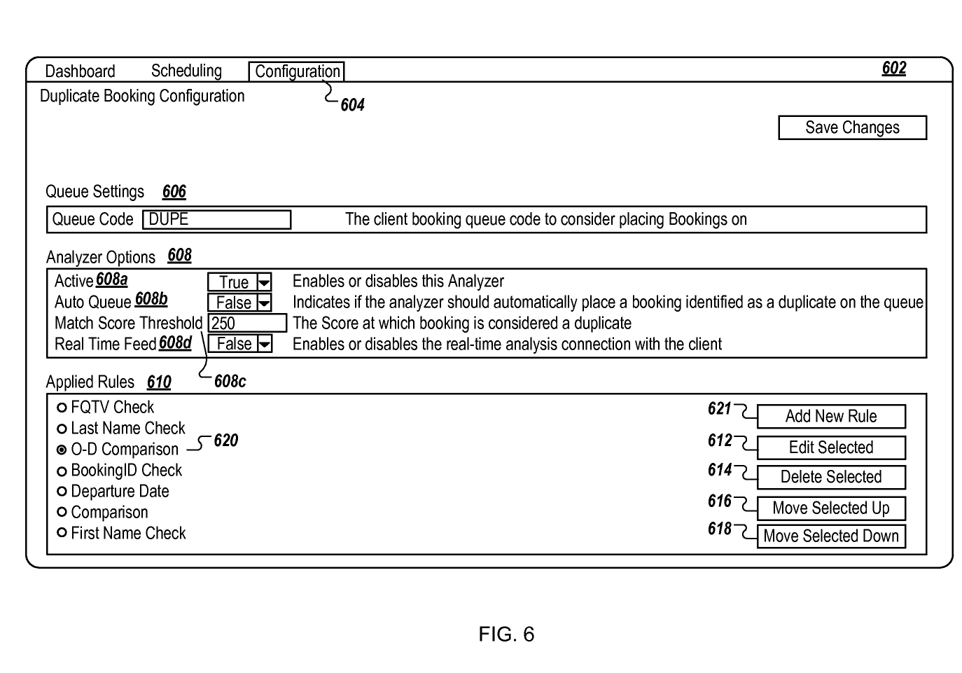

FIG. 6 is a screen shot of an example configuration user interface (UI) 602 for a revenue integrity system. For example, referring to FIG. 1, the client computing system 112 can display the configuration UI 602 on the client display device 112a when the administrator 113 selects the “Configuration” tab 604. The example configuration UI 602 provides the administrator 113 with the information and rules available for use by the revenue integrity engine 202 and the duplicate booking analyzer. The administrator 113 can view and modify queue settings 606 and analyzer options 608. The administrator 113 can select one or more rules from an applied rules list 610.

The configuration UI 602 displays the current settings for the queue settings 606, the analyzer options 608 and the selected rules in the applied rules list 610. In some cases, the queue settings 606, the analyzer options 608 and the selected rules in the applied rules list 610 can be the default values provided by the revenue integrity system provider. In some cases, the queue settings 606, the analyzer options 608 and the selected rules in the applied rules list 610 can be the values previously selected by the administrator 113. The queue settings 606 can be selected to determine the booking code to use for the booking data. The analyzer options 608 can allow the administrator 113 to enable or disable the duplicate bookings analyzer using an active control 608a. Other analyzer options 608 include the selection of placing an identified duplicate booking on the queue using an auto queue control 608b. The administrator 113 can enter the threshold score above which a booking is considered a duplicate using a match score threshold control 608c. The administrator 113 can enable or disable the real-time streaming of alerts to the client computing system 112 using a real time feed control 608d.

The administrator 113 can select one or more rules to apply to the booking data from the applied rules list 610. In addition, the user can edit a selected rule by activating an edit selected button 612 in order to display a user interface for editing the selected rule. The user can delete a selected rule by activating a delete selected button 612. The administrator 113 can determine the order in which to apply the rules to the booking data by selecting a rule and activating a move selected up button 616 or a move selected down button 618 in order to place the rule one level higher or one level lower, respectively, in the applied rules list 610. The administrator 113 can activate an add new rule button 621 in order to display a user interface for adding a new rule.

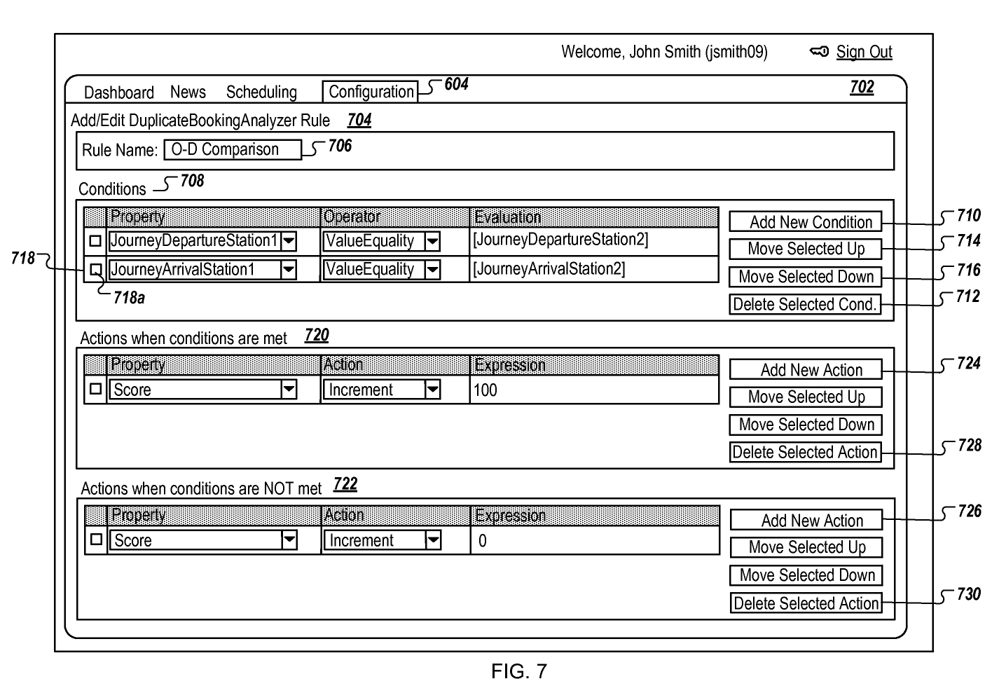

FIG. 7 is a screen shot of an example add/edit rule user interface (UI) 702 for adding or editing one or more rules in a revenue integrity system. For example, referring to FIG. 1, the client computing system 112 can display the add/edit rule UI 702 on the client display device 112a when the administrator 113 selects the edit selected button 612 or the add new rule button 621 in the configuration UI 602 shown in FIG. 6.

The example add/edit rule UI 702 can provide the administrator 113 a selection of rules available for use by the revenue integrity engine 202 and the duplicate booking analyzer. The example add/edit rule UI 702 can allow the administrator 113 to change the conditions for a rule and the actions taken when the conditions are met and when the conditions are not met by the rule.

For example, referring to FIGS. 6 and 7, the administrator 113 can select an O-D Comparison rule 620 from the applied rules list 610. The administrator 113 can choose to edit the O-D Comparison rule 620 by next activating the edit selected button 612. Upon selection, the add/edit rule UI 702 is activated in the configuration tab 604 displaying an add/edit duplicate booking analyzer rule user interface (UI) 704 indicating the O-D comparison as the rule being edited in the rule name window 706. The administrator 113 can select one or more conditions from a conditions list 708 for the rule. In addition, the administrator 113 can activate an add new condition button 710 to add a condition to the conditions list 708. The administrator 113 can also delete a selected condition by activating the delete selected condition button 712. The administrator 113 can determine the order in which to apply the conditions to the booking data. The administrator 113 can select a condition from the conditions list 708 (e.g., select condition 718 by activating a check box 718a associated with the condition 718) and then activate a move selected up button 714 or a move selected down button 716 in order to place the condition one level higher or one level lower, respectively, in the conditions list 708.

The administrator can add actions to an actions when conditions are met list 720 and an actions when conditions are not met list 722 by activating an add new action button 724 and an add new action button 726, respectively. The administrator can delete actions from the actions when conditions are met list 720 and the actions when conditions are not met list 722 by activating a delete selected action button 728 and a delete selected action button 730, respectively. The administrator 113 can also determine the order in which the actions are applied for the rule by using move selected up buttons and move selected down buttons provided for the actions when conditions are met list 720 and the actions when conditions are not met list 722. These buttons can be used with the lists 720 and 722 in a similar manner as the move selected up button 714 and the move selected down button 716 for the conditions list 708.

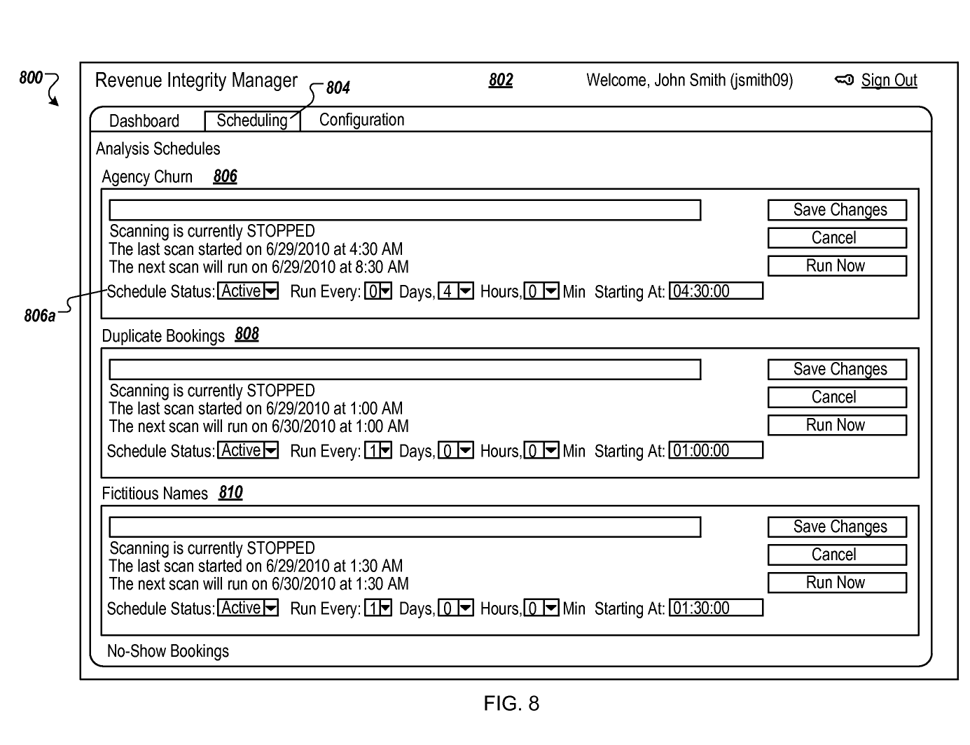

FIG. 8 is a screen shot 800 of an example scheduling user interface (UI) 802 for a revenue integrity system. For example, referring to FIG. 1, the client computing system 112 can display the scheduling UI 802 on the client display device 112a when the administrator 113 selects the “Scheduling” tab 804. The example scheduling UI 802 allows the administrator 113 to manage analysis schedules for each analyzer. The screen shot 800 shows an agency churn scheduler 806 for use by the administrator 113 in order to manage the scheduling of the agency churn analyzer. The screen shot 800 shows a duplicate bookings scheduler 808 for use by the administrator 113 in order to manage the scheduling of the duplicate booking analyzer. The screen shot 800 shows a fictitious names scheduler 810 for use by the administrator 113 in order to manage the scheduling of the fictitious name analyzer. For each scheduler the administrator 113 can select the schedule status and, in addition, select how often to run the analyzer. For example, for the agency churn scheduler 806, the administrator can set an agency churn schedule status 806a to “Active”, additionally selecting to run the analyzer every four hours starting at 4:30 am.

Each scheduler displays the status for the respective analyzer, when the last scan of the booking data was performed (the last time the booking data was analyzed) and when the next scan of the booking data is scheduled to be performed (the next time the booking data will be analyzed). For example, for the agency churn scheduler 806, the scheduling UI 802 indicates scanning is currently stopped, the last scan was started on Jun. 29, 2010 at 4:30 am, the next scan will run on Jun. 29, 2010 at 8:30 am.

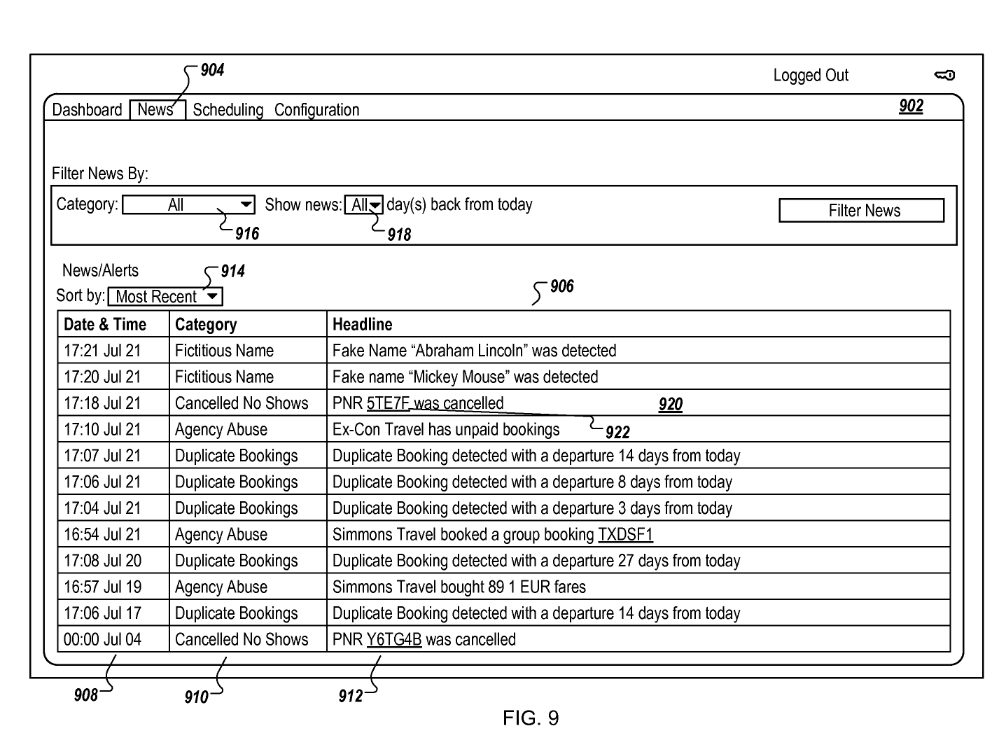

FIG. 9 is a screen shot of an example news user interface (UI) 902 for a revenue integrity system. For example, referring to FIG. 1, the client computing system 112 can display the news UI 902 on the client display device 112a when the administrator 113 selects the “News” tab 904. The news UI 902 displays a news/alerts list 906 that includes a date and time 908 for the alert, a category 910 for the alert and a headline 912 that provides a brief description of the rule violation that prompted the alert. A sort control 914 allows the administrator to select how to sort the entries in the new/alerts list 906. In addition, the administrator 113 can use a category control 916 to filter the entries in the news/alerts list 906 by category, displaying only those alerts that are in the selected category in the news/alerts list 906. The administrator can use a show news control 918 to select how many days of alerts to include in the new/alerts list 906.

A headline (e.g., headline 920) can include a link 922 to the booking data associated with the alert. The link 922 can be the record locator for the booking data. For example, when the administrator 113 selects the link 922, the booking data associated with the record locator may be displayed in a pop-up window (not shown) on the news UI 902.

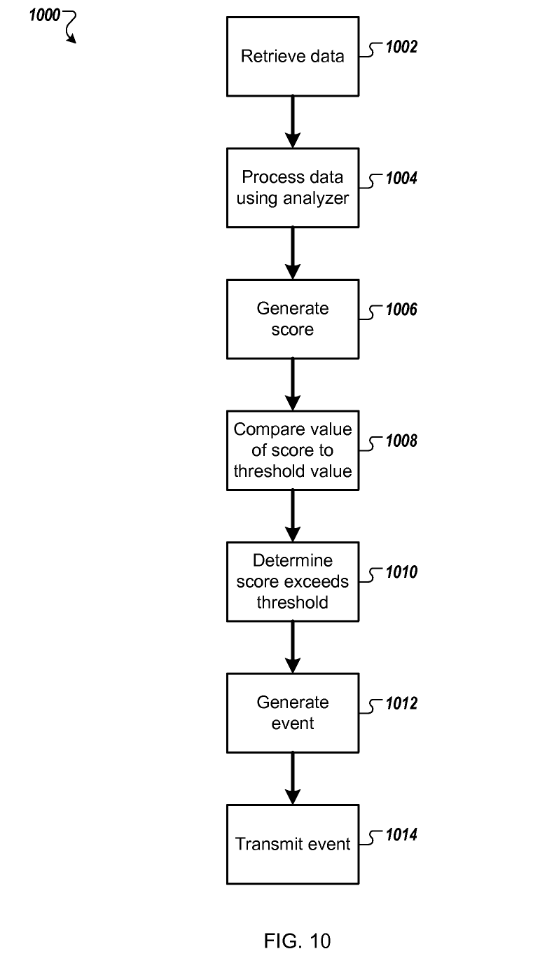

FIG. 10 is a flow chart of an example process 1000 that can execute implementations of the present disclosure. Briefly, the example process 1000 includes a process for monitoring the integrity of booking data in a revenue integrity system. The example process 1000 will be described with reference to FIGS. 1 and 2.

Data is retrieved (1002). For example, the revenue integrity engine 202 can retrieve booking data from the booking repository 204. The data is processed using an analyzer (1004). For example, the revenue integrity engine 202 can process the booking data using an analyzer selected from the analyzer repository 206. A score is generated (1006). For example, based on the results of the analysis of the booking data by the analyzer, a score is generated. The value of the score is compared to a threshold value (1008). For example, the revenue integrity engine 202 compares the value of the generated score to the threshold value associated with the analyzer. It is determined that the value of the score exceeds the threshold value (1010). For example, because of the comparison, the revenue integrity engine 202 determines the value of the generated score exceeds the threshold value. An event is generated (1012). For example, the revenue integrity engine 202 flags the booking data. The revenue integrity computing system 110 can generate an event based on the flagging of the booking data. The event is transmitted (1014). For example, the revenue integrity computing system 110 transmits the event along with the booking data to the client computing system 112 for display on the client display device 112a.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A computer-implemented method of monitoring booking data, comprising:
retrieving data from a computer-readable storage device, the data comprising booking data;
processing the data using an analyzer of a plurality of analyzers to generate at least one score;
comparing a value of the at least one score to a threshold value;
determining that the value exceeds the threshold value;
generating an event in response to determining that the value exceeds the threshold value, the event indicating a presence of one or more criteria that generated the data; and
transmitting the event to a computing device to be displayed to a user of the computing device.

2. The method of claim 1, wherein the threshold value is determined by a user.

3. The method of claim 1, wherein the analyzer embodies one or more user-defined heuristics.

4. The method of claim 3, wherein each of the one or more user-defined heuristics can be provided as one or more user-defined rules.

5. The method of claim 1, wherein processing the data comprises comparing the data to a rule, and generating the at least one score based on the rule being violated.

6. The method of claim 5, wherein the rule is defined based on input provided by a customer.

7. The method of claim 1, wherein the value of the at least one score is determined by a user.

8. The method of claim 1, wherein transmitting the event is performed on a real-time basis, when the event is generated.

9. The method of claim 1, wherein the analyzer of a plurality of analyzers is selected by a user.

10. The method of claim 1, wherein the booking data comprises airline booking data.

11. The method of claim 1, wherein the booking data comprises transportation booking data.

12. The method of claim 1, wherein the booking data comprises ancillary sales data corresponding to a booking.

13. A system, comprising:
a computing device; and
a computer-readable medium coupled to the computing device and having instructions stored thereon which, when executed by the computing device, cause the computing device to perform operations for monitoring booking data, the operations comprising:
retrieving data from a computer-readable storage device, the data comprising booking data;
processing the data using an analyzer of a plurality of analyzers to generate at least one score;
comparing a value of the at least one score to a threshold value;
determining that the value exceeds the threshold value;
generating an event in response to determining that the value exceeds the threshold value, the event indicating a presence of one or more criteria that generated the data; and
transmitting the event to a computing device to be displayed to a user of the computing device.

14. The system of claim 13, wherein the threshold value is determined by a user.

15. The system of claim 13, wherein the analyzer embodies one or more user-defined heuristics.

16. The system of claim 15, wherein each of the one or more user-defined heuristics can be provided as one or more user-defined rules.

17. The system of claim 13, wherein the operation of processing the data comprises comparing the data to a rule, and generating the at least one score based on the rule being violated.

18. The system of claim 17, wherein the rule is defined based on input provided by a customer.

19. The system of claim 13, wherein the value of the at least one score is determined by a user.

20. The system of claim 13, wherein operation of transmitting the event is performed on a real-time basis, when the event is generated.

21. The system of claim 13, wherein the analyzer of a plurality of analyzers is selected by a user.

22. The system of claim 13, wherein the booking data comprises airline booking data.

23. The system of claim 13, wherein the booking data comprises transportation booking data.

24. The system of claim 13, wherein the booking data comprises ancillary sales data corresponding to a booking.

25. A computer-readable medium coupled to the one or more processors and having instructions stored thereon which, when executed by the one or more processors, cause the processors to perform operations for monitoring booking data, the operations comprising:
retrieving data from a computer-readable storage device, the data comprising booking data;
processing the data using an analyzer of a plurality of analyzers to generate at least one score;
comparing a value of the at least one score to a threshold value;
determining that the value exceeds the threshold value;
generating an event in response to determining that the value exceeds the threshold value, the event indicating a presence of one or more criteria that generated the data; and
transmitting the event to a computing device to be displayed to a user of the computing device.

26. The medium of claim 25, wherein the threshold value is determined by a user.

27. The medium of claim 25, wherein the analyzer embodies one or more user-defined heuristics.

28. The medium of claim 27, wherein each of the one or more user-defined heuristics can be provided as one or more user-defined rules.

29. The medium of claim 25, wherein the operation of processing the data comprises comparing the data to a rule, and generating the at least one score based on the rule being violated.

30. The medium of claim 29, wherein the rule is defined based on input provided by a customer.

31. The medium of claim 25, wherein the value of the at least one score is determined by a user.

32. The medium of claim 25, wherein the operation of transmitting the event is performed on a real-time basis, when the event is generated.

33. The medium of claim 25, wherein the analyzer of a plurality of analyzers is selected by a user.

34. The medium of claim 25, wherein the booking data comprises airline booking data.

35. The medium of claim 25, wherein the booking data comprises transportation booking data.

36. The medium of claim 25, wherein the booking data comprises ancillary sales data corresponding to a booking.
